(19) United States
(12) Patent Application Publication
(10) Pub. No.: US 2014/0359516 A1
(43) Pub. Date: Dec. 4, 2014

(54) SENSING USER INPUT TO CHANGE ATTRIBUTES OF RENDERED CONTENT

(71) Applicant: Kobo Incorporated, Toronto (CA)

(72) Inventor: Anthony O'DONOGHUE, Toronto (CA)

(73) Assignee: Kobo Incorporated, Toronto (CA)

(21) Appl. No.: 13/903,766

(22) Filed: May 28, 2013

(51) Int. Cl. G06F 3/0483

(52) U.S. Cl. CPC G06F 3/0483
USPC 715/776

(57) ABSTRACT

A device such as an electronic book reader stores content and a setting for an attribute of the content. When the content is rendered on a display screen of the device, the rendered content is formatted based on the setting. In response to sensing a movement on or near a sensing device (e.g., a touchscreen that may be part of the display screen), the setting is changed and the rendered content is reformatted on the display screen using the new setting.

### BACKGROUND

Tablet computer systems, electronic book (e-book) readers, smart phones, and other types of portable devices are increasingly popular. These types of devices have features in common, such as high resolution touchscreens that provide an easy-to-use and intuitive user interface and that allow users to interact directly with what is being displayed.

In an e-reader, for example, a page of an e-book is rendered and displayed. The electronic version of the page that is displayed looks very much like the conventional non-electronic version of the page.

One advantage that an e-book has over a conventional non-electronic book is that characteristics of the electronic page can be changed to satisfy a user's preferences. For example, if the user prefers larger-sized text, the user can change the size of the font being used.

However, changing a characteristic such as font size, while not difficult, nevertheless requires the user to perform a series of operations that may not be intuitive. First, the user needs to open a toolbar (if such a toolbar is not persistently displayed) that includes an icon related to font size. Next, the user needs to select (e.g., touch) that icon to open a window that allows the user to change font size. Within that window, the user then needs to select the new font size. For example, the window may include, or allow the user to open, a drop-down menu that lists the available font sizes. Alternatively, the window may include a slider bar that allows the user to select a new font size by moving an indicator along the slider bar. In any case, the user selects the new font size, and then needs to close the windows, menus, etc., that were opened in order to return and view the electronic page without obstruction. All told, multiple steps are needed in order to change font size.

### SUMMARY

Accordingly, a system and/or methodology that allows a user to more conveniently and more intuitively make changes to rendered and displayed content would be advantageous.

Embodiments according to the present invention permit the use of a simple and intuitive movement (e.g., a gesture) to control the manner in which content is rendered and displayed. In one embodiment, a system such as an electronic book (e-book) reader stores content and a setting for an attribute of the content. When the content is rendered on a display screen, the rendered content is initially formatted according to the setting. In response to sensing a movement on or near a sensing device (e.g., a touchscreen that may be part of the display screen), the setting is changed and the rendered content is reformatted on the display screen using the new setting.

The types of movements/gestures include, for example, pinch close, stretch open, scroll, tap (one time or multiple times), press (short or long), flick, and rotate. These movements can be made by a user with his or her finger or fingers or with a stylus, in contact with or proximate to the sensing device. Advantageously, these types of movements/gestures are intuitive and already familiar to many people.

Attributes that can be controlled in this manner include, for example, font size, line spacing, margin setting, background color, font color, font face, alignment, brightness setting, and contrast setting. In one embodiment, a user can specify which attribute is to be controlled using a particular movement/gesture. In other words, for a particular type of movement/gesture, a user can select an attribute from a list of attributes, and the system is thereby programmed to associate that attribute with that particular movement/gesture, and will subsequently change a setting for the selected attribute in response to that particular movement/gesture.

For example, the system can be programmed to increase and decrease font size using a stretch open gesture and a pinch close gesture, respectively. Significantly, the change in font size is accomplished differently from a conventional magnify/reduce operation, which merely expands or contracts the rendered content. More specifically, in embodiments according to the present invention, when the font size is increased, for example, the content is also line-wrapped and may be repaginated. In other words, the rendered content remains visible without horizontal scrolling.

When an attribute setting is changed, it may or may not be implemented in real time. In one embodiment, in response to sensing a movement as described above, information is displayed to dynamically indicate the value of the setting as it is being changed. In one such embodiment, a slider bar is displayed, and the position of an indicator on the slider bar indicates the current (changing) value of the setting. For example, a user can use a stretch open gesture to increase the font size of the rendered content; while the user is making this gesture, the indicator moves along the slider bar to provide feedback indicating the degree to which the font size is being increased.

In summary, in embodiments according to the present invention, rendered content can be readily changed (e.g., reformatted) using an intuitive user-based movement/gesture. Instead of multiple actions, a single intuitive and mostly familiar action (e.g., a pinch close or stretch open gesture) can be used to control an attribute (change an attribute setting).

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of an example of a computing system capable of implementing embodiments according to the present disclosure.

FIG. 2A illustrates a frontal view of an example of a computing system, showing a display screen, in an embodiment according to the present invention.

FIG. 2B illustrates examples of gestures that can be used to change attributes of rendered content, in an embodiment according to the present invention.

FIGS. 3A and 3B illustrate a frontal view of an example of a computing system, showing a display screen, in an embodiment according to the present invention.

FIG. 4 illustrates an example of a graphical user interface element that can be used to provide feedback when an attribute setting is changed in an embodiment according to the present invention.

FIGS. 5A and 5B illustrate examples of graphical user interface elements that can be used to determine user preferences in an embodiment according to the present invention.

FIG. 6 is a flowchart of an example of a computer-implemented method for changing an attribute setting in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

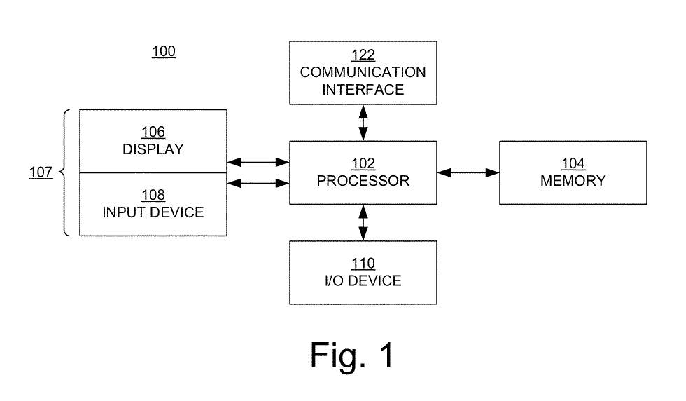

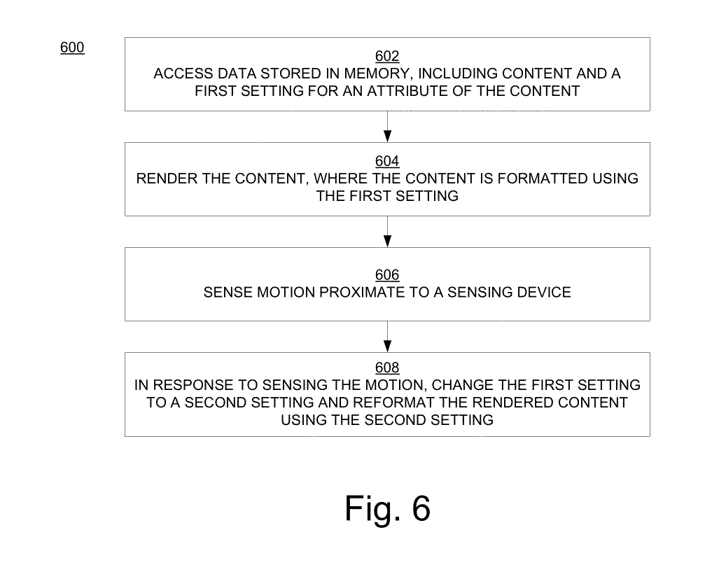

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “accessing,” “displaying,” “rendering,” “sensing,” “changing,” “resizing,” “line-wrapping,” “receiving,” “formatting,” or the like, refer to actions and processes (e.g., flowchart 600 of FIG. 6) of a computer system or similar electronic computing device or processor (e.g., the computing system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computing system or computing device 100 capable of implementing embodiments according to the present invention. The computing system 100 broadly represents any single or multi-processor computing device or system capable of executing computer-readable instructions. Examples of a computing system 100 include, without limitation, an electronic book (e-book) reader, laptop, tablet, or handheld computer. The computing system 100 may also be a type of computing device such as a cell phone, smart phone, media player, camera, or the like. Depending on the implementation, the computing system 100 may not include all of the elements shown in FIG. 1, and/or it may include elements in addition to those shown in FIG. 1.

In its most basic configuration, the computing system 100 may include at least one processor 102 and at least one memory 104. The processor 102 generally represents any type or form of processing unit capable of processing data or interpreting and executing instructions. In certain embodiments, the processor 102 may receive instructions from a software application or module. These instructions may cause the processor 102 to perform the functions of one or more of the example embodiments described and/or illustrated herein.

The memory 104 generally represents any type or form of volatile or non-volatile storage device or medium capable of storing data and/or other computer-readable instructions. In certain embodiments the computing system 100 may include both a volatile memory unit (such as, for example, the memory 104) and a non-volatile storage device (not shown).

The computing system 100 also includes a display device 106 that is operatively coupled to the processor 102. The display device 106 is generally configured to display a graphical user interface (GUI) that provides an easy to use interface between a user and the computing system.

The computing system 100 also includes an input device 108 that is operatively coupled to the processor 102. The input device 108 may include a sensing device (a “touchscreen”) configured to receive input from a user and to send this information to the processor 102. The processor 102 interprets the touches in accordance with its programming. The input device 108 may be integrated with the display device 106 or they may be separate components. In the illustrated embodiment, the input device 108 is a touchscreen that is positioned over or in front of the display device 106. The input device 108 and display device 106 may be collectively referred to herein as a touchscreen display 107. There are many different technologies that can be used to sense a user's input, such as but not limited to technologies based on capacitive sensing and technologies based on resistive sensing. Some touchscreens can function even if the user does not actually touch the surface of the touchscreen; that is, some touchscreens can sense a user's finger that is near (but not touching) the surface of the touchscreen. The term “touchscreen” is used in the widely accepted manner to include any type or form of sensing device that can sense a user input, including those types of devices that do not require a user's touch.

The communication interface 122 of FIG. 1 broadly represents any type or form of communication device or adapter capable of facilitating communication between the example computing system 100 and one or more additional devices. For example, the communication interface 122 may facilitate communication between the computing system 100 and a private or public network including additional computing systems. Examples of a communication interface 122 include, without limitation, a wired network interface (such as a network interface card), a wireless network interface (such as a wireless network interface card), a modem, and any other suitable interface. In one embodiment, the communication interface 122 provides a direct connection to a remote server via a direct link to a network, such as the Internet. The communication interface 122 may also indirectly provide such a connection through any other suitable connection. The communication interface 122 may also represent a host adapter configured to facilitate communication between the computing system 100 and one or more additional network or storage devices via an external bus or communications channel.

As illustrated in FIG. 1, the computing system 100 may also include at least one input/output (I/O) device 110. The I/O device 110 generally represents any type or form of input device capable of providing/receiving input or output, either computer- or human-generated, to/from the computing system 100. Examples of an I/O device 110 include, without limitation, a keyboard, a pointing or cursor control device (e.g., a mouse), a speech recognition device, or any other input device.

Many other devices or subsystems may be connected to computing system 100. Conversely, all of the components and devices illustrated in FIG. 1 need not be present to practice the embodiments described herein. The devices and subsystems referenced above may also be interconnected in different ways from that shown in FIG. 1. The computing system 100 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into the computing system 100. All or a portion of the computer program stored on the computer-readable medium may then be stored in the memory 104. When executed by the processor 102, a computer program loaded into the computing system 100 may cause the processor 102 to perform and/or be a means for performing the functions of the example embodiments described and/or illustrated herein. Additionally or alternatively, the example embodiments described and/or illustrated herein may be implemented in firmware and/or hardware.

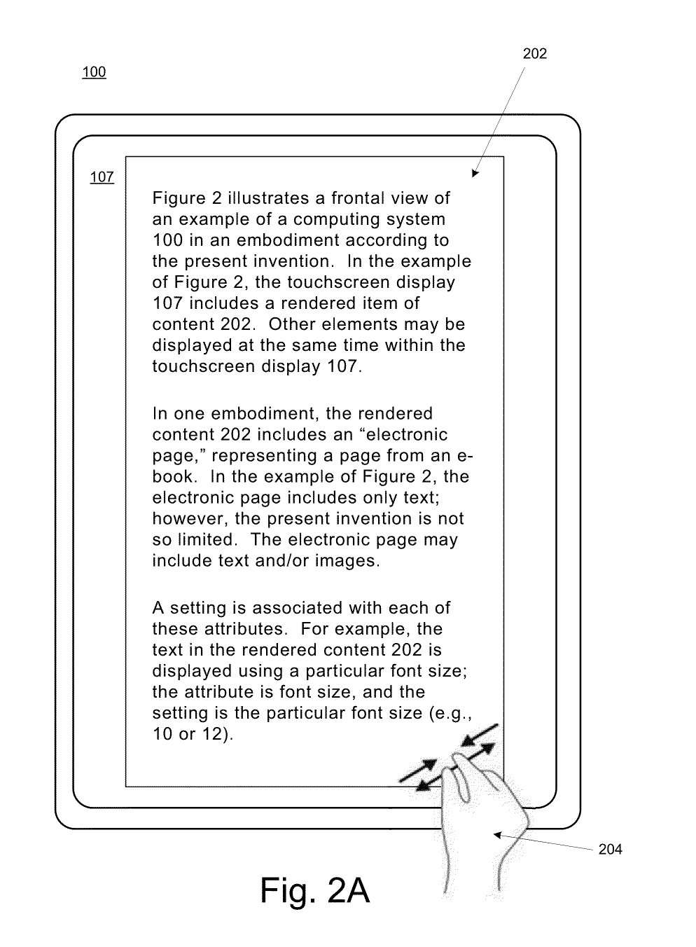

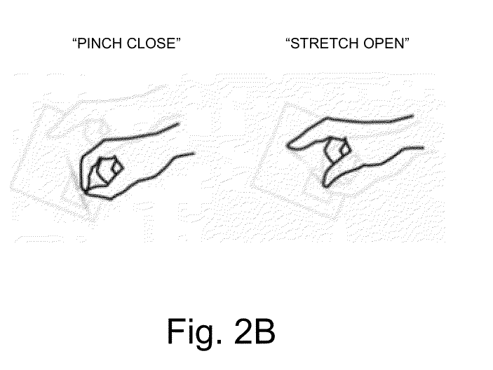

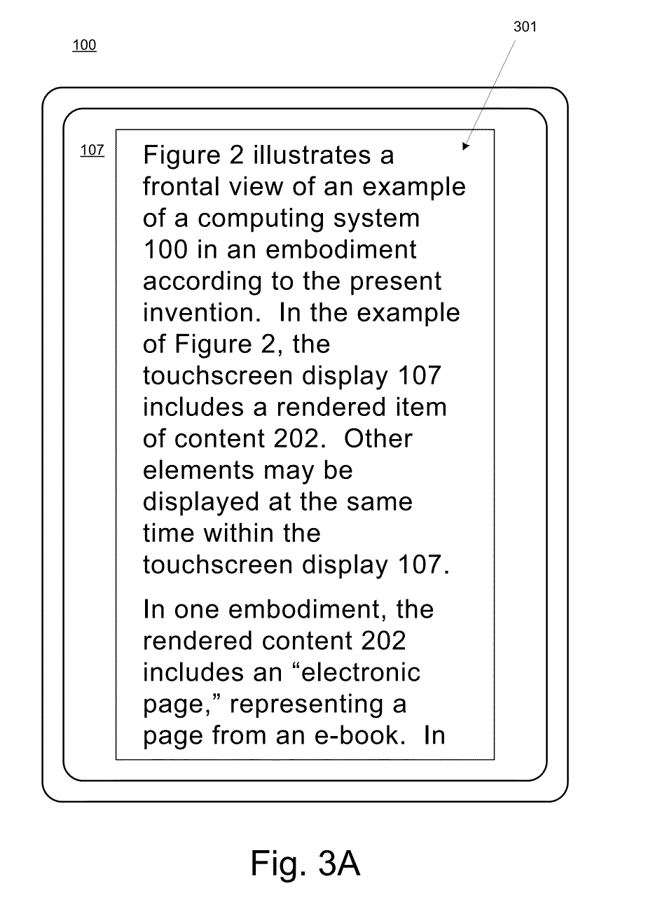

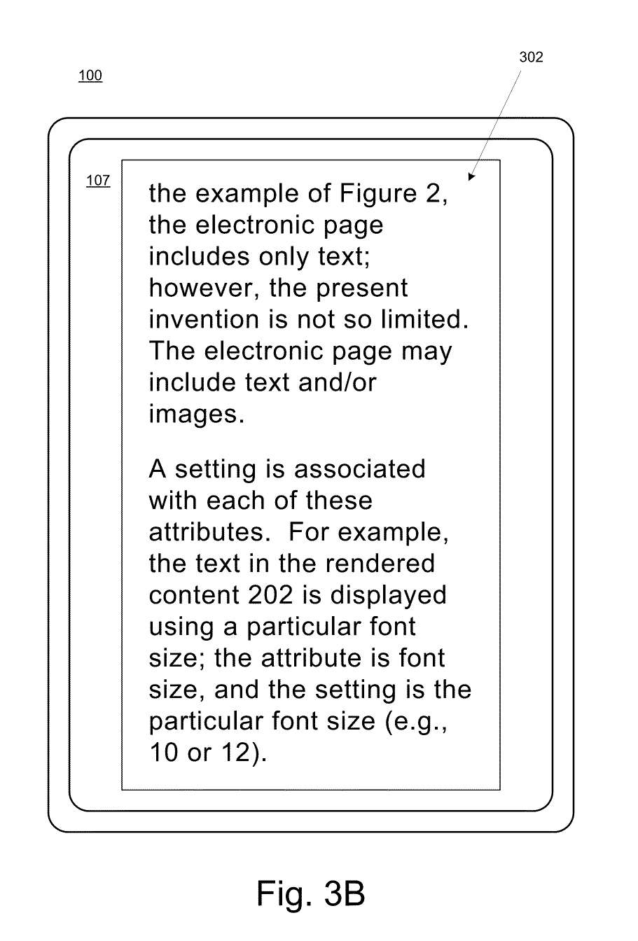

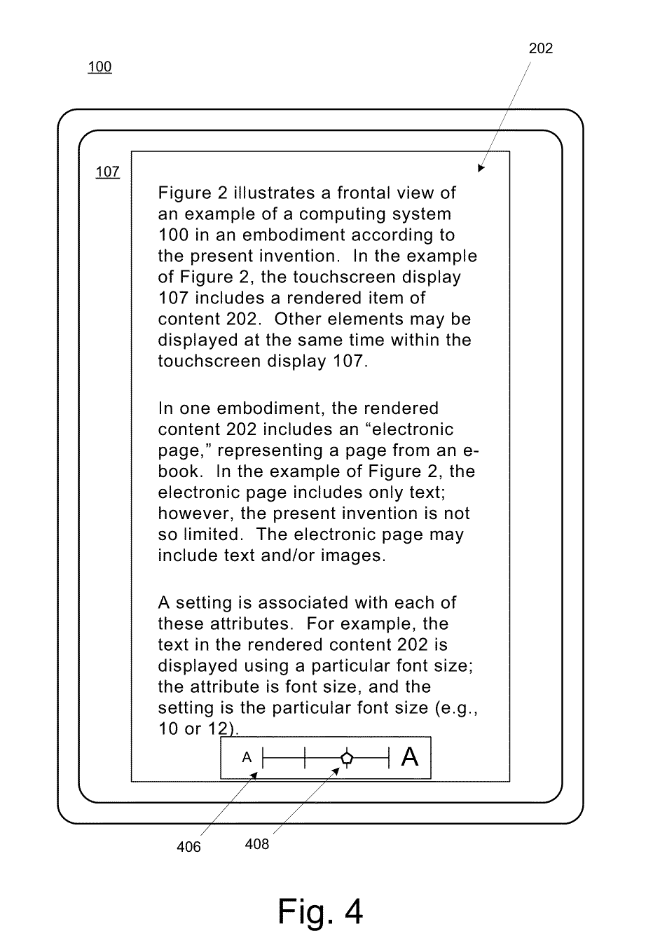

FIG. 2A illustrates a frontal view of an example of a computing system 100 in an embodiment according to the present invention. In the example of FIG. 2A, the touchscreen display 107 includes a rendered item of content 202. Other elements may be displayed at the same time within the touchscreen display 107.

In one embodiment, the rendered content 202 includes an electronic page, representing a page from an e-book. In the example of FIG. 2A, the electronic page includes only text. However, the present invention is not so limited; the electronic page may include text and/or images.

In general, various attributes are associated with the rendered content 202. These attributes include, but are not limited to:

the font size of the text within the electronic page;

the spacing between lines of the text within the electronic page;

the margins (the distances from the left, right, top, and bottom margins of the electronic page to the content within the electronic page);

the background color of the electronic page;

the font color (the color(s) of the text);

the font face (the type(s) of font used in the text, such as Arial, and also effects such as bold, underlining, and/or italics);

the brightness of the touchscreen display 107; and

the contrast of the touchscreen display.

A setting is associated with each of these attributes. For example, the text in the rendered content 202 is displayed using a particular font size, in which case the attribute is font size and the setting is the particular font size (e.g., 10, 12, etc.). The setting may be a default value or it may be a value specified by or selected by a user.

In embodiments according to the present invention, to change a setting for an attribute of the rendered content 202, the user makes a movement (e.g., a gesture) on or near the touchscreen display 107. These movements can be made by a user with his or her finger or fingers or with a stylus, in contact with or proximate to the sensing device. In general, the user's movement (gesture) is made within sensing distance of the touchscreen display 107. The movement (gesture) is represented by element 204 in FIG. 2A. In response to sensing such a movement, the setting is changed automatically, and the rendered content is automatically reformatted on the display screen using the new setting.

The types of movements/gestures include, for example, pinch close, stretch open, scroll, tap (one time or multiple times), press (short or long), flick, and rotate. Advantageously, these types of movements/gestures are intuitive and already familiar to many people. FIG. 2B illustrates examples of a pinch close gesture and a stretch open gesture.

Advantageously, the movement/gesture is made without having to open a toolbar, window, or the like, and without the use of drop-down menus, slider bars, and the like. In essence, a single intuitive and perhaps familiar action (e.g., pinch close or stretch open) can be used to change the setting for an attribute.

To change font size, for example, the user can make a particular type of motion and, in response to that motion being sensed (detected), the size of the font in the rendered content 202 is changed automatically. For example, the user can use a stretch open gesture to increase font size (see FIGS. 3A and 3B).

Significantly, the change in font size that is achieved using the stretch open gesture as just described is accomplished differently from a conventional magnify/reduce operation, which might appear to change font size but instead merely expands or contracts the rendered content. More specifically, in embodiments according to the present invention, when the font size of the rendered content 202 in FIG. 2A is increased, for example, the rendered content is line-wrapped and also repaginated if necessary, resulting in the example shown in FIGS. 3A and 3B. FIG. 3A shows a first page 301 of the rendered content 202 of FIG. 2A after line-wrapping and repagination, and

FIG. 3B shows a second page 302 of the rendered content 202 of FIG. 2A after line-wrapping and repagination. A user can navigate from one page to the next in a well-known manner.

Similarly, the font size can be decreased using a pinch close gesture. If, for example, the font size of the rendered content in pages 301 and 302 of FIGS. 3A and 3B is reduced, then the rendered content is line-wrapped and also repaginated if necessary, resulting in the reformatted content 202 shown in FIG. 2A.

Thus, in embodiments according to the present invention, when the font size is increased, for example, the rendered content remains visible without horizontal scrolling, allowing the text to be read from top to bottom without horizontal scrolling. In contrast, conventional magnification results in content becoming invisible in the horizontal direction (and usually in the vertical direction as well). Note that embodiments according to the present invention, in which movements/gestures are used to change attribute settings, can be utilized in addition to a conventional magnify/reduce feature. In other words, for example, the system 100 can be implemented with both the capability to change font size in the rendered content as described above and the capability to magnify/reduce the rendered content. That is, changing font size as described herein is a separate feature independent of a conventional magnify/reduce feature.

When a setting for an attribute is changed, it may or may not be implemented in real time. In one embodiment, in response to sensing a movement as described above, information is displayed to indicate the value of the setting as it is being changed. In one such embodiment, a slider bar is displayed, and the position of an indicator on the slider bar indicates the new or changing value of the setting. In this embodiment, the setting is changed in response to a gesture as described above; the slider bar and indicator are simply used to provide feedback.

FIG. 4 illustrates an example of a graphical user interface element (a slider bar 406 and an indicator 408) that can be used to provide feedback when an attribute setting is changed in an embodiment according to the present invention. For example, a user can use a stretch open gesture to increase the font size of the rendered content 202. In response to and while the user is making this gesture, the slider bar 406 is displayed within the touchscreen display 107. The indicator 408 moves along the slider bar 406 (e.g., from left to right) to provide feedback indicating the degree to which the font size is being increased. Similarly, if the font size is decreased in response to, for example, a pinch close gesture, the indicator 408 moves in the opposite direction along the slider bar 406.

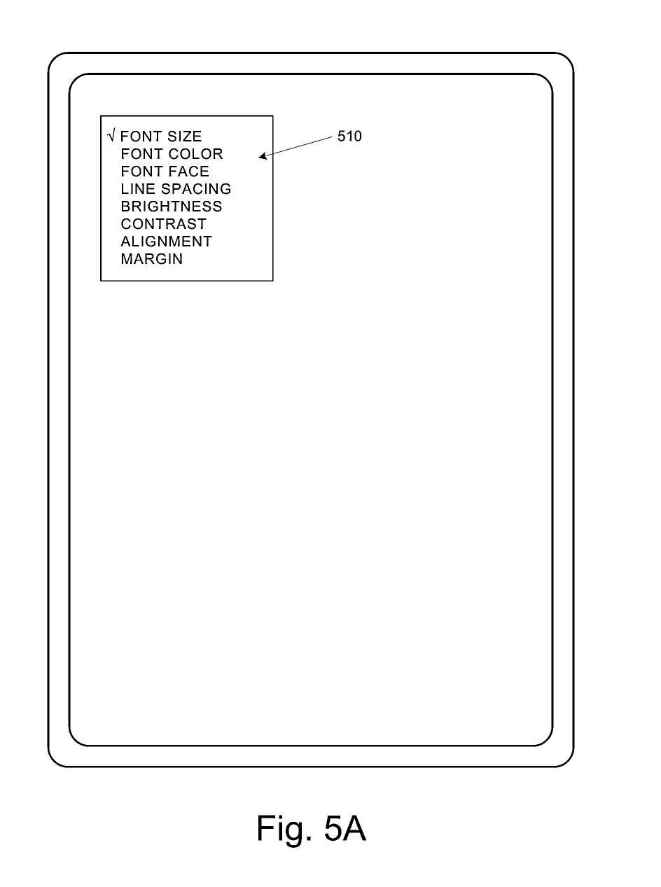

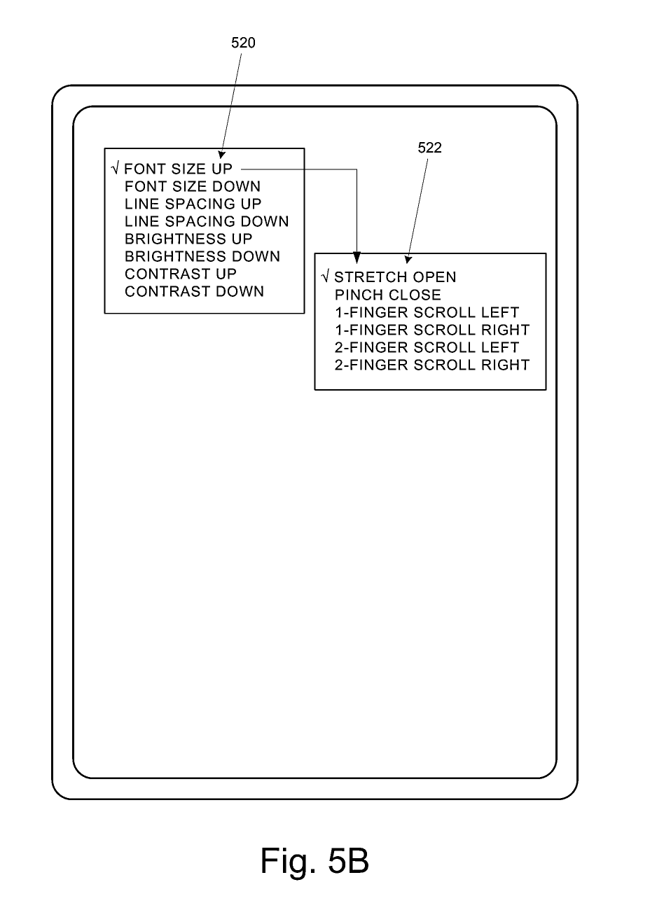

With reference to FIG. 5A, in one embodiment, a user can specify which attribute is to be controlled in response to a particular type of user movement. In one such embodiment, a user can access a list of attributes (e.g., the drop-down menu 510) and select an attribute from the list. In response, the system 100 (FIG. 1) is automatically programmed to change the setting for the selected attribute in response to subsequent user movements. Thus, the user can program the system 100 according to his or her preferences, and can change the meaning of a gesture. For example, if the system 100 is set up such that the stretch open gesture increases font size, the user can use the drop-down menu 510 to change the meaning of the gesture, such that it can be used instead to increase brightness, for example.

With reference to FIG. 5B, in one embodiment, a user can specify which attribute is to be controlled in response to a particular user movement. In one such embodiment, a user can access a list of attributes (e.g., the drop-down menu 520) and select an attribute from the list. For a selected attribute, the user can also access a second list of gestures (e.g., the drop-down menu 522) and select a gesture that is linked to that attribute. In response, the system 100 (FIG. 1) is automatically programmed to change the setting for the selected attribute in response to the selected gesture. For example, a user can program the system 100 so that a one-finger horizontal scroll in one direction increases brightness and a one-finger scroll in the other direction decreases brightness, and a two-finger horizontal scroll in one direction increases contrast and a two-finger scroll in the other direction decreases contrast.

Thus, in general, the use of movements/gestures to change settings can be customized according to user preferences, and different gestures can have different meanings. That is, the user can specify which setting is associated with which gesture, and one gesture can be used to change a setting for one attribute, and another gesture can be used to change a setting for a different attribute.

FIG. 6 is a flowchart 600 of an example of a computer-implemented method for changing an attribute setting in an embodiment according to the present invention. The flowchart 600 can be implemented as computer-executable instructions residing on some form of computer-readable storage medium (e.g., using the computing system 100 of FIG. 1).

In block 602 of FIG. 6, data stored in memory (e.g., the memory 104 of FIG. 1) is accessed. The data includes content and a first setting for an attribute of the content.

In block 604 of FIG. 6, the content is rendered on a display screen (e.g., the touchscreen display 107 of FIG. 1). The content rendered on the display screen is formatted using the first setting for the attribute.

In block 606 of FIG. 6, motion proximate to a sensing device (e.g., the touchscreen) is sensed.

In block 608, in response to the motion being sensed, the first setting is changed to a second setting, and the content that is rendered on the display screen is reformatted using the second setting.

In summary, embodiments according to the present invention can allow a user to more conveniently and more intuitively make changes to rendered and displayed content. For example, instead of multiple actions, a single intuitive and generally familiar action (e.g., a pinch close gesture or a stretch open gesture) can be used to control an attribute (e.g., change the attribute's setting).

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A computer-readable storage medium having computer-executable instructions that, when executed, cause a computing system to perform a method comprising:
accessing data stored in memory of the computing system, the data comprising content and a first setting for an attribute of the content;
rendering the content on a display screen of the computing system, the display screen comprising a sensing device, wherein the content rendered on the display screen is formatted using the first setting for the attribute;
sensing a motion proximate to the sensing device; and
in response to the motion, changing the first setting to a second setting and reformatting the content rendered on the display screen using the second setting for the attribute.

2. The computer-readable storage medium of claim 1 wherein the content comprises an electronic book (e-book) and the computing system comprises an e-book reader.

3. The computer-readable storage medium of claim 1 wherein the attribute is selected from the group consisting of: font size; line spacing; margin setting; background color; font color; font face; brightness setting; and contrast setting.

4. The computer-readable storage medium of claim 1 wherein the motion comprises a user-generated gesture selected from the group consisting of: pinch close; stretch open; scroll; tap; press; flick; and rotate.

5. The computer-readable storage medium of claim 1 wherein the method further comprises, in response to changing the first setting, displaying information that indicates a value for the second setting.

6. The computer-readable storage medium of claim 1 wherein the content rendered on the display screen comprises an electronic page comprising text, wherein the operation of changing further comprises resizing the text and wherein the operation of reformatting further comprises line-wrapping the text within the boundaries of the electronic page.

7. The computer-readable storage medium of claim 1 wherein the attribute is selectable by a user from a plurality of attributes.

8. A system comprising:
a processor;
a display coupled to the processor;
a sensing device coupled to the processor; and
memory coupled to the processor, the memory have stored therein instructions that, if executed by the system, cause the system to execute operations comprising:
accessing a file stored in the memory, the file comprising data comprising content;
displaying the content as text, the text formatted using a first setting for a first attribute of the text;
sensing user-generated movement relative to the sensing device; and
in response to the user-generated movement, changing the first setting to a second setting and reformatting the text using the second setting.

9. The system of claim 8 wherein the content comprises an electronic book (e-book).

10. The system of claim 8 wherein the first attribute is selected from the group consisting of: font size; line spacing; margin setting; background color; font color; font face; brightness setting; and contrast setting.

11. The system of claim 8 wherein the user-generated movement is selected from the group consisting of: pinch close; stretch open; scroll; tap; press; flick; and rotate.

12. The system of claim 8 wherein the operations further comprise, in response to changing the first setting, displaying information that indicates a value for the second setting.

13. The system of claim 8 wherein the content is displayed as an electronic page, wherein the operation of changing further comprises resizing the text and wherein the operation of reformatting further comprises line-wrapping the text within the boundaries of the electronic page.

14. The system of claim 8 wherein the operations further comprise, in response to user input, associating the user-generated movement with a second attribute instead of the first attribute.

15. A system comprising:
a processor;
a display coupled to the processor, the display comprising a touchscreen; and
memory coupled to the processor, the memory have stored therein instructions that, if executed by the system, cause the system to execute operations comprising:
displaying an electronic page comprising text;
sensing a motion proximate to the touchscreen;
in response to the motion, resizing the text within the electronic page that is displayed; and
in response to the resizing, line-wrapping the text that is resized within the electronic page that is displayed.

16. The system of claim 15 wherein the motion comprises a user-generated gesture selected from the group consisting of: pinch close; stretch open; scroll; tap; press; flick; and rotate.

17. The system of claim 15 wherein the operations further comprise, after sensing the motion and before resizing the text that is displayed, displaying information that indicates the text's new size.

18. The system of claim 15 wherein the operations further comprise displaying a list that identifies a plurality of attributes of the electronic page that are controllable via the touchscreen, wherein a user makes a selection from the list to designate which of the attributes is to change in response to another motion proximate to the touchscreen.

19. The system of claim 18 wherein the listing comprises attributes selected from the group consisting of: font size; line spacing; margin setting; background color; font color; font face; brightness setting; and contrast setting.

20. The system of claim 15 wherein the system comprises an e-book reader.
